(19) United States
(12) Patent Application Publication
(10) Pub. No.: US 2009/0249009 A1
(43) Pub. Date: Oct. 1, 2009

(54) METHOD FOR COPYING DATA FROM AN EXTERNAL STORAGE DEVICE TO A COMPUTER, AND COMPUTER CAPABLE OF PERFORMING THE METHOD

(75) Inventors: Yuan-Chan Lee, Taipei Hsien (TW); Feng-Hsing Chiang, Taipei Hsien (TW); Jung-Chun Lin, Taipei Hsien (TW)

Correspondence Address: SHEPPARD, MULLIN, RICHTER & HAMPTON LLP, 990 Marsh Road, Menlo Park, CA, 94025, US

(73) Assignee: Wistron Corporation, Taipei Hsien (TW)

(21) Appl. No.: 12/205,808

(22) Filed: Sep. 5, 2008

(30) Foreign Application Priority Data
Apr. 1, 2008 (TW) 097111855

(51) Int. Cl. G06F 12/16; G06F 15/177; G06F 12/00

(52) U.S. Cl. 711/162; 711/166; 713/2; 711/E12.103; 711/E12.001

(57) ABSTRACT

In a method for copying data from an external storage device to a computer, the computer is provided with a basic input/output system (BIOS) program used for performing the method. The method includes the steps of: (a) after the computer is powered on, initializing the external storage device in response to a hot key trigger; and (b) storing the data from the external storage device to the computer. Since data is copied from the external storage device to the computer immediately after powering on the computer, efficiency is enhanced.

### CROSS-REFERENCE TO RELATED APPLICATION

This application claims priority of Taiwanese application no. 097111855, filed on Apr. 1, 2008.

### BACKGROUND OF THE INVENTION

1. Field of the Invention

This invention relates to a method for copying data and a computer performing the method, more particularly to a method for copying data from an external storage device to a computer, and a computer performing the method.

2. Description of the Related Art

After a power switch button of a computer is pressed, the computer performs a standard booting procedure known as Power on Self-Test (POST) in accordance with a basic input/output system (BIOS) program residing in a read-only memory (ROM). The primary purpose of the standard booting procedure is to perform a check of components inside the computer in order to determine whether the components are functioning normally. The components are checked in the following order: CPU-ROM-BIOS-System Clock-DMA-64 KB RAM-IRQ-Display Adaptor Card, etc. Under normal conditions, the standard booting procedure proceeds rapidly. After completion of the standard booting procedure, the computer automatically displays an operating system splash screen.

When a user needs to copy data from an external storage device, such as a memory card, to a built-in storage device in the computer, a lengthy series or operations must precede execution of the copy operation, including the aforementioned standard booting procedure, as well as loading of the operating system, opening of a file manager, and selection of files to be copied. Among the aforesaid operations, the loading of the operating system is particularly time consuming. Storage of data from the external storage device to the computer is therefore inconvenient.

### SUMMARY OF THE INVENTION

Since at present, copying data from an external storage device to a built-in storage device in a computer is time consuming and therefore inconvenient, an improvement is desired. If data can be copied from the external storage device to the built-in storage device inside the computer immediately after powering on the computer, the current waiting period prior to execution of the copy operation could be eliminated.

Therefore, the object of the present invention is to provide a method for copying data from an external storage device to a computer, and a computer capable of performing the method.

According to one aspect of the present invention, there is provided a method for copying data from an external storage device to a computer. The computer is provided with a basic input/output system (BIOS) program used for performing the method. The method comprises the steps of:

(a) after the computer is powered on, initializing the external storage device in response to a hot key trigger; and

(b) storing the data from the external storage device to the computer.

According to another aspect of the present invention, there is provided a computer-readable data storage medium. The computer-readable data storage medium comprises a basic input/output system (BIOS) program for causing a computer connected to an external storage device to perform the following steps:

(a) initializing the external storage device in response to a hot key trigger;

(b) generating a set-up interface for receiving an external command used to determine whether to store data from the external storage device to the computer;

(c) determining whether to store the data in accordance with the external command thus received; and

(d) when it is determined to store the data, storing the data from the external storage device to the computer.

According to yet another aspect of the present invention, there is provided a computer adapted for copying data from an external storage device. The computer comprises a processor and a computer-readable data storage medium. The computer-readable data storage medium is coupled electrically to the processor and includes a basic input/output system (BIOS) program.

After the computer is powered on, the processor executes the BIOS program for initializing the external storage device in response to a hot key trigger. The processor then determines whether to store the data from the external storage device to the computer, and stores the data from the external storage device to the computer according to a result of determination made thereby.

Convenient copying of data from an external storage device to a computer, as provided by the method for copying data from an external storage device to a computer, and a computer capable of performing the method according to the present invention, results in a further advantage of supporting cost effective utilization of storage space in the external storage device, which is typically more expensive than the built-in storage device in the computer.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic system block diagram of a preferred embodiment of a computer adapted for copying data from an external storage device according to the present invention;

FIG. 2 is a flow chart of a preferred embodiment of a method for copying data from an external storage device to a computer according to the present invention; and

FIG. 3 is a schematic diagram of the preferred embodiment of a computer adapted for copying data from an external storage device.

### DETAILED DESCRIPTION OF THE PREFERRED EMBODIMENT

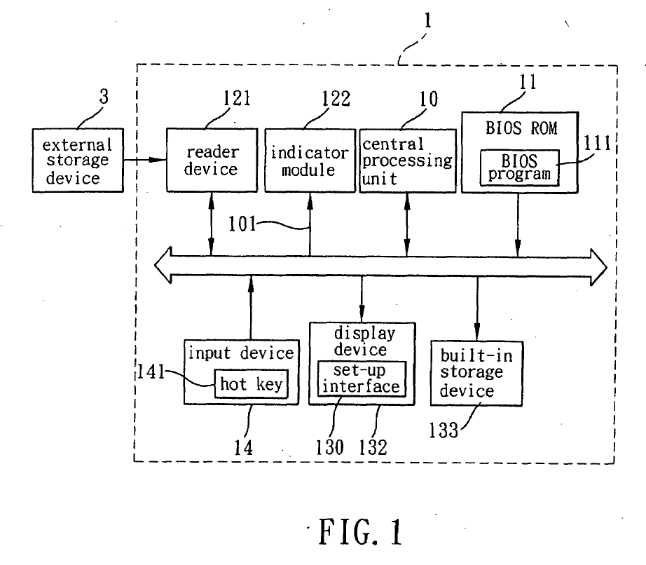

FIG. 1 illustrates a preferred embodiment of a computer 1 adapted for copying data from an external storage device 3 according to the present invention.

The computer 1 comprises a central processing unit or processor 10, a basic input/output system read-only memory (BIOS ROM) 11, a reader device 121, an indicator module 122, a display device 132, a built-in storage device 133, and an input device 14 having a hot key 141. In this embodiment, the external storage device 3 is a media card, such as a Secure Digital (SD) media card, a Memory Stick (MS) media card, or a Compact Flash (CF) media card, and the reader device 121 of the computer 1 is a memory card reader.

The BIOS ROM 11 includes a BIOS program 111 for causing the processor 10, after the computer 1 is powered on, to automatically perform a standard booting procedure, that incorporates steps of the method for copying data from an external storage device to a computer according to the present invention when the external storage device 3 is connected to the computer 1.

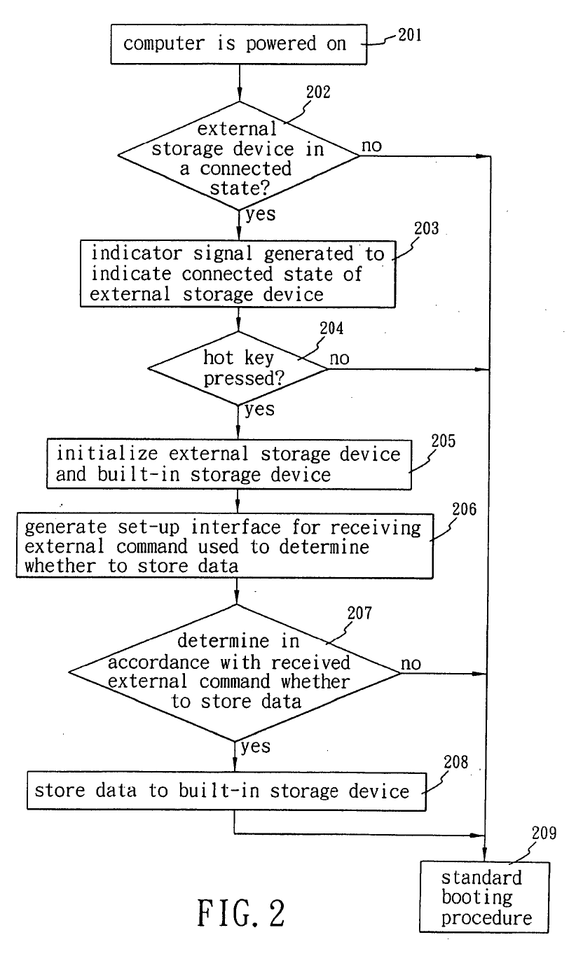

Referring to FIG. 2, a preferred embodiment of the method for copying data from an external storage device to a computer according to the present invention, as performed by the computer 1, is shown to comprise the steps of:

In step 201, the computer 1 is powered on. The flow then proceeds to step 202.

In step 202, the central processing unit 10 determines whether the external storage device 3 is in a connected state (i.e., whether the external storage device 3 is connected to the computer 1). If it is determined that the external storage device 3 is in a connected state, the flow proceeds to step 203. Otherwise, the flow proceeds to step 209, wherein the central processing unit 10 proceeds with performing the standard booting procedure in accordance with the BIOS program 111.

In step 203, the indicator module 122 of the computer 1 generates an indicator signal 101 (see FIG. 1) indicating the connected state of the external storage device 3. The flow then proceeds to step 204.

In step 204, the central processing unit 10 determines whether the hot key 141 has been pressed (i.e., whether there is a hot key trigger). If it is determined that the hot key 141 has been pressed, the flow proceeds to step 205. Otherwise, the flow proceeds to step 209, wherein the central processing unit 10 proceeds with performing the standard booting procedure in accordance with the BIOS program 111.

In step 205, the central processing unit 10 initializes the external storage device 3 and the built-in storage device 133 in accordance with the BIOS program 111. An initialization program for the external storage device 3 included in the BIOS program 111 can be written as follows:

mov eax, (80000000h+(Media-Card PCI Address)+(Resource Registers))

mov dx, 0cf8h;

out dx, eax;

mov dx, 0cfch;

ior eax, (Resource Settings);

out dx, eax;

An initialization program for the built-in storage device 133 included in the BIOS program 111 can be written as follows:

mov eax, (80000000h+(NB storageAddress)+(Resource Registers))

mov dx, 0cf8h;

out dx, eax;

mov dx, 0cfch;

ior eax, (Resource Settings);

out dx, eax;

In step 206, a set-up interface 130 is generated and displayed by the display device 132 for receiving an external command used to determine whether to store the data from the external storage device 3 to the built-in storage device 133 of the computer 1. The flow then proceeds to step 207.

In step 207, the central processing unit 10 determines whether to store the data in accordance with the external command thus received. If it is determined to store the data, the flow proceeds to step 208. Otherwise, the flow proceeds to step 209, wherein the central processing unit 10 proceeds with performing the standard booting procedure in accordance with the BIOS program 111.

In step 208, the central processing unit 10 stores the data from the external storage device 3 to the built-in storage device 133 in the computer 1. The flow then proceeds to step 209, wherein the central processing unit 10 proceeds with performing the standard booting procedure in accordance with the BIOS program 111.

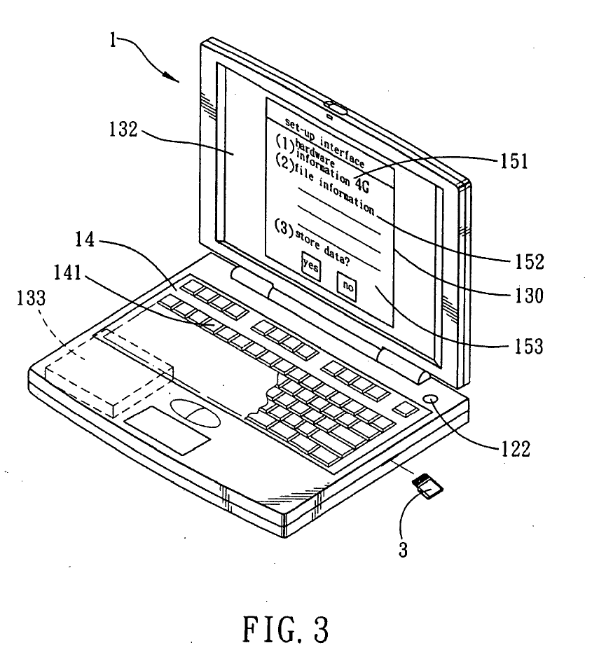

Referring to FIG. 3, when it is desired to copy data from the external storage device 3 to the computer 1, which in this embodiment is a notebook computer, the external storage device 3 is first connected to the computer 1. Next, the computer 1 is powered on. The indicator module 122 then indicates the connected state of the external storage device 3, such as generating a light output to indicate successful connection. The hot key 141, which can be a predetermined function key, a combination of keys, etc., is then pressed in order to trigger the computer 1 to initialize the external storage device 3.

The display device 132 then displays the set-up interface 130 for determining whether to store the data from the external storage device 3 to the computer 1. In this embodiment, the set-up interface 130 displays hardware information 151 and file information 152 of the external storage device 3, and an option 153 to store the data. As an example, the ‘Y’ key on the input device 14 is then pressed in order to select the ‘yes’ response to the option 153 to store the data. The data from the external storage device 3 is then stored to the built-in storage device 133 of the computer 1.

The above-described embodiment provides the set-up interface 130 for user convenience. However, other embodiments can be designed to skip the set-up interface in order to further save time. Copying the data from the external storage device 3 to the built-in storage device 133 in the computer 1 can thus proceed automatically after pressing the hot key 141 for initializing the external storage device 3 and the built-in storage device 133.

In sum, the present invention provides a method for copying data from an external storage device 3 to a computer 1, and a computer 1 capable of performing the method, which, aside from increasing convenience of storing the data from the external storage device 3 to the computer 1, supports cost effective utilization of storage space in the external storage device 3, which is typically more expensive than the built-in storage device 133 inside the computer 1.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for copying data from an external storage device to a computer, the computer being provided with a basic input/output system (BIOS) program used for performing said method, said method comprising the steps of:
(a) after the computer is powered on, initializing the external storage device in response to a hot key trigger; and
(b) storing the data from the external storage device to the computer.

2. The method for copying data from an external storage device to a computer as claimed in claim 1, further comprising, between step (a) and step (b), the steps of:
(b-1) generating a set-up interface for receiving an external command used to determine whether to store the data from the external storage device to the computer;
(b-2) determining whether to store the data in accordance with the external command thus received; and
(b-3) when it is determined to store the data, proceeding to step (b).

3. The method for copying data from an external storage device to a computer as claimed in claim 2, wherein step (b-1) includes displaying at least one of hardware information and file information of the external storage device on the set-up interface.

4. The method for copying data from an external storage device to a computer as claimed in claim 1, further comprising the step of:
(a-1) after the computer is powered on, generating an indicator signal that indicates a connected state of the external storage device.

5. A computer-readable data storage medium comprising a basic input/output system (BIOS) program for causing a computer connected to an external storage device to perform the following steps:
(a) initializing the external storage device in response to a hot key trigger;
(b) generating a set-up interface for receiving an external command used to determine whether to store data from the external storage device to the computer;
(c) determining whether to store the data in accordance with the external command thus received; and
(d) when it is determined to store the data, storing the data from the external storage device to the computer.

6. The computer-readable data storage medium as claimed in claim 5, wherein the set-up interface displays at least one of hardware information and file information of the external storage device thereon.

7. A computer adapted for copying data from an external storage device, said computer comprising:
a processor; and
a computer-readable data storage medium that is coupled electrically to said processor and that includes a basic input/output system (BIOS) program;
wherein, after said computer is powered on, said processor executes said BIOS program for initializing the external storage device in response to a hot key trigger, determines whether to store the data from the external storage device to said computer, and stores the data from the external storage device to said computer according to result of determination made thereby.

8. The computer as claimed in claim 7, further comprising a set-up interface, which, after said processor determines connection of said computer to the external storage device, is used to receive an external command for determining whether to store the data from the external storage device to said computer.

9. The computer as claimed in claim 8, wherein said set-up interface displays at least one of hardware information and file information of the external storage device thereon.

10. The computer as claimed in claim 7, further comprising an indicator module for indicating a connected state of the external storage device.
